(19) United States
(12) Patent Application Publication
(10) Pub. No.: US 2008/0298609 A1
(43) Pub. Date: Dec. 4, 2008

(54) ELECTROMAGNETIC MICROPHONE

(75) Inventor: Chao-Chih Chang, Taichung City (TW)

Correspondence Address: Brinks Hofer Gilson & Lione/Ann Arbor, 524 South Main Street, Suite 200, Ann Arbor, MI, 48104, US

(73) Assignee: TAIWAN CAROL ELECTRONICS CO., LTD., Taichung City (TW)

(21) Appl. No.: 11/756,983

(22) Filed: Jun. 1, 2007

(51) Int. Cl. H04R 1/22

(52) U.S. Cl. 381/177

(57) ABSTRACT

A microphone includes first and second magnet units disposed in a head housing and spaced apart from each other in an axial direction of the head housing. The first and second magnet units generate respectively first and second magnetic fields. A response unit is mounted in the head housing, is disposed between the first and second magnet units in the axial direction, and includes a diaphragm, and a conductive wiring disposed at the diaphragm. When the diaphragm vibrates between the first and second magnet units in response to an external sound wave signal, an electrical signal corresponding to the sound wave signal is induced in the conductive wiring as a result of action of the first and second magnetic fields.

### BACKGROUND OF THE INVENTION

1. Field of the Invention

The invention relates to a microphone, more particularly to an electromagnetic microphone.

2. Description of the Related Art

At present, there have been provided dynamic and condenser microphones. The dynamic microphone includes a diaphragm that carries a voice coil and that is disposed within a magnetic field generated by a permanent magnet such that the voice coil generates an electrical signal corresponding to an external sound wave signal during vibration of the diaphragm in response to the external sound wave signal. In such a configuration, since the weight of the diaphragm is approximate to that of the voice coil, the vibration characteristic of the diaphragm varies with the frequency of the external sound wave signal, thereby affecting frequency response characteristic of the electrical signal generated by the voice coil. As such, attenuation of the electrical signal in high and low frequency bands occurs as shown in FIG. 1. On the other hand, the condenser microphone includes a condenser, and a bias power connected across the condenser. The condenser has two electrodes, one of which is a diaphragm. Hence, a distance between the electrodes of the condenser varies with vibration of the diaphragm in response to an external sound wave signal, thereby varying a voltage across the electrodes of the condenser so as to obtain an electrical signal corresponding to the distance variation. In such a configuration, although the condenser microphone can reduce attenuation of the frequency response characteristic compared to the dynamic microphone because the weight of the diaphragm is less than that of the dynamic microphone, it is necessary for the condenser to be provided with the bias power.

### SUMMARY OF THE INVENTION

Therefore, the object of the present invention is to provide a microphone that can overcome the aforesaid drawbacks of the prior art.

According to the present invention, a microphone comprises:

a head housing;

first and second magnet units disposed in the head housing and spaced apart from each other in an axial direction of the head housing, the first and second magnet units generating respectively first and second magnetic fields; and

a response unit mounted in the head housing, disposed between the first and second magnet units in the axial direction, and including a diaphragm, and a conductive wiring disposed at the diaphragm.

When the diaphragm vibrates between the first and second magnet units in response to an external sound wave signal, an electrical signal corresponding to the sound wave signal is induced in the conductive wiring as a result of action of the first and second magnetic fields.

### BRIEF DESCRIPTION OF THE DRAWINGS

Other features and advantages of the present invention will become apparent in the following detailed description of the preferred embodiments with reference to the accompanying drawings, of which:

FIG. 1 is a plot illustrating frequency response of a conventional dynamic microphone;

FIG. 2 is a schematic sectional view showing the first preferred embodiment of a microphone according to the present invention;

FIG. 3 is a schematic sectional view showing the second preferred embodiment of a microphone according to the present invention;

FIG. 4 is a schematic sectional view showing the third preferred embodiment of a microphone according to the present invention;

FIG. 5 is a schematic sectional view showing the fourth preferred embodiment of a microphone according to the present invention;

FIG. 6 is a schematic sectional view showing the fifth preferred embodiment of a microphone according to the present invention;

FIG. 7 is a schematic view showing a modified diaphragm;

FIG. 8 is a schematic sectional view of the modified diaphragm taken along line VIII-VIII in FIG. 7;

FIG. 9 is a schematic view showing another modified diaphragm; and

FIG. 10 is a schematic sectional view of the modified diaphragm taken along line X-X in FIG. 9.

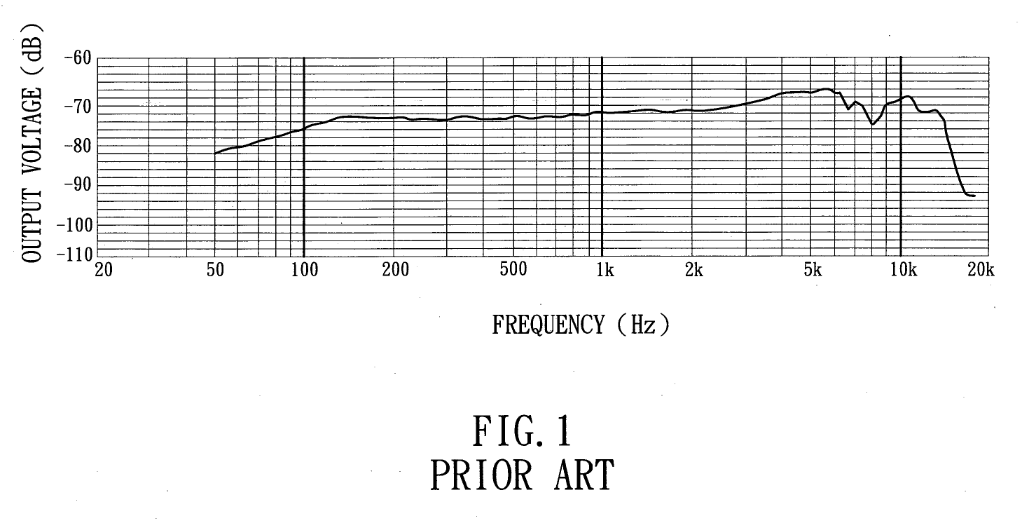

### DETAILED DESCRIPTION OF THE PREFERRED EMBODIMENTS

Before the present invention is described in greater detail, it should be noted that like elements are denoted by the same reference numerals throughout the disclosure.

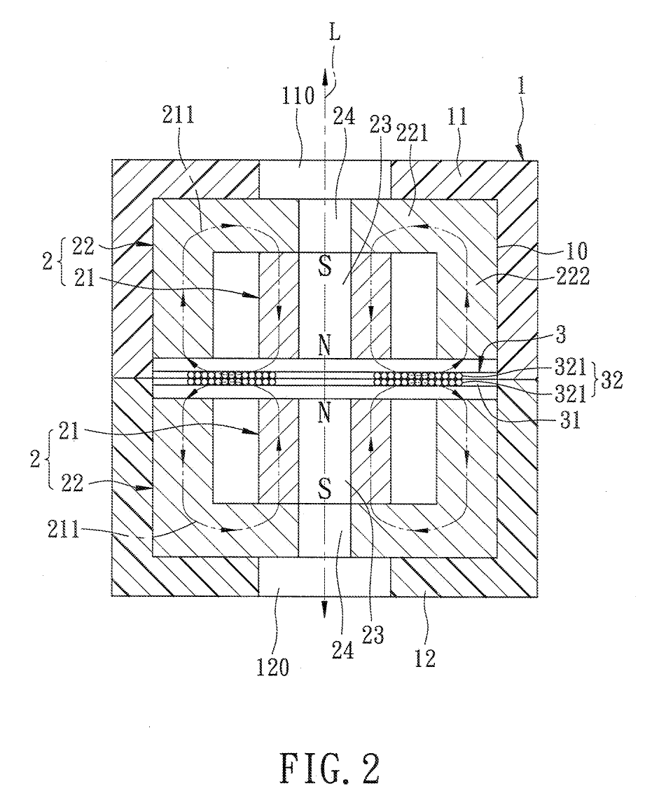

Referring to FIG. 2, the first preferred embodiment of a microphone according to the present invention is shown to include ahead housing 1, first and second magnet units 2, and a response unit 3.

The head housing 1 defines a chamber 101, and has first and second walls 11, 12 opposite to each other in an axial direction (L) of the head housing 1. Each of the first and second walls 11, 12 is formed with a through hole 110, 120 in fluid communication with the chamber 10. In this embodiment, the through hole 110 in the first wall 11 of the head housing 1 functions as access for propagation of an external sound wave signal into the chamber 10 in the head housing 1, whereas the through hole 120 in the second wall 12 of the head housing 1 acts to balance pressure in the chamber 10 in the head housing 1.

The first and second magnet units 2 are mounted in the chamber 10 in the head housing 1, are spaced apart from each other in the axial direction (L), and are disposed respectively adjacent to the first and second walls 11, 12 of the head housing 1. The first and second magnet units 2 generate respectively first and second magnetic fields. In this embodiment, the first and second magnet units are identical, and have the same magnetic poles disposed adjacent to each other. Each of the first and second magnet units 2 includes a magnet 21 generating a plurality of magnetic lines 211 of force (only one is shown) that constitute a corresponding one of the first and second magnetic fields, and a yoke 22 for permitting the magnetic lines of force 211 to pass therethrough. For each of the first and second magnet units 2, in this embodiment, the yoke 22 is in the form of a cap that has a flat wall portion 221 abutting against a corresponding one of the first and second walls 11, 12 of the head housing 1, and formed with a through hole unit that is a central through hole 24 in fluid communication with the through hole 110, 120 in the corresponding one of the first and second walls 11, 12 of the head housing 1, and an annular surrounding wall 222 extending in the axial direction (L) from a periphery of the flat wall portion 221 toward the other one of the first and second walls 11, 12 of the head housing 1; and the magnet 21 is covered by the yoke 22, is surrounded spacedly by the annular surrounding wall 222 of the yoke 22, has a north pole disposed adjacent to that of the other one of the first and second magnet units 2, and is in the form of a ring that has a central hole 23 extending in the axial direction (L) and in fluid communication with the through hole 24.

The response unit 3 is mounted in the head housing 1, is disposed between the first and second magnet units 2 in the axial direction (L), and includes a circular diaphragm 31, and a conductive wiring 32 made of a conductive material selected from copper, aluminum, etc, and disposed at the diaphragm 31. In this embodiment, the conductive wiring 32 includes a spiral wiring embedded in the diaphragm 31 using CVD process, photolithography or plating process and having two spiral wiring sections 321 that are disposed respectively in two parallel planes.

In such as a configuration, when the diaphragm 31 vibrates between the first and second magnet units 2 in response to the external sound wave signal propagated thereto via the through hole 110, and the through hole 24 in the yoke 22 and the central hole 23 in the magnet 21 of the first magnet unit 2, an electrical signal corresponding to the sound wave signal is induced in the conductive wiring 32 as a result of action of the first and second magnetic fields.

In sum, the microphone of this invention can generate an electrical signal corresponding to an external sound wave signal without the need for a bias power required in the aforesaid condenser microphone. Furthermore, since the weight of the conductive wiring 32 of the response unit 3 is much less than that of the voice coil of the aforesaid dynamic microphone, the diaphragm 31 can be designed to be relatively thin as compared to that of the aforesaid dynamic microphone. Therefore, attenuation of the electrical signal in high and low frequency bands can be minimized, and rapid transient response and low handling noise can be attained.

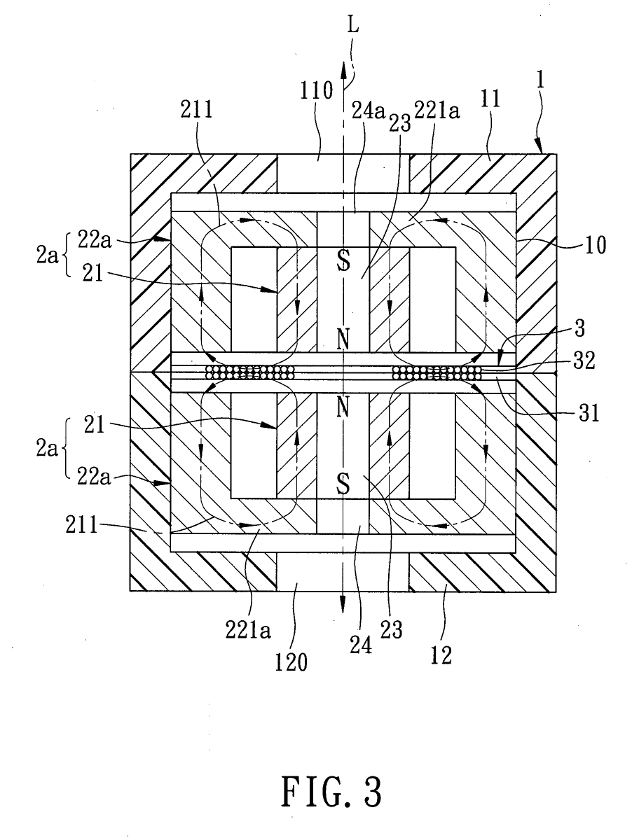

FIG. 3 illustrates the second preferred embodiment of a microphone according to this invention, which is a modification of the first preferred embodiment. Unlike the previous embodiment, the flat wall portion (221a) of the yoke (22a) of each of the first and second magnet units (2a) is spaced apart from the corresponding one of the first and second walls 11, 12 of the head housing 1. The through hole (24a) in the yoke (22a) of each of the first and second magnet units (2a) is in fluid communication with a part of the chamber 10 that is in fluid communication with the through hole 110, 120 in the corresponding one of the first and second walls 11, 12 of the head housing 1. As such, the external sound wave signal is propagated to the response unit 3 via the through hole 110 in the first wall 11 of the head housing 1, the part of the chamber 10, and the through hole (24a) in the yoke (22a) and the central hole 23 in the magnet 21 of the first magnet unit (2a).

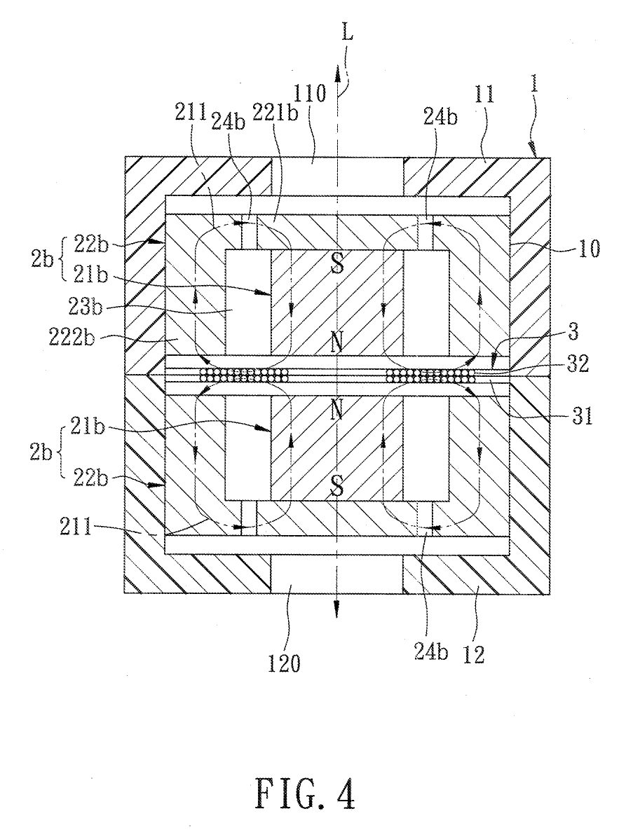

FIG. 4 illustrates the third preferred embodiment of a microphone according to this invention, which is a modification of the second preferred embodiment. In this embodiment, for each of the first and second magnet units (2b), the through hole unit in the flat wall portion (221b) of the yoke (22b) includes a plurality of through holes (24b), each of which is further in fluid communication with an annular space between the magnet (21b) in the form of a column, and the annular surrounding wall portion (222b) of the yoke (22b). As such, the external sound wave signal is propagated to the response unit 3 via the through hole 110 in the first wall 11 of the head housing 1, the part of the chamber 10, and the through holes (24b) in the yoke (22a) and the annular space (23b) between the magnet (21b) and the annular surrounding wall portion (222b) of the yoke (22b) of the first magnet unit (2b). Since the magnets (21b) of the first and second magnet units (2b) do not have through holes, the first and second magnet units (2b) provide greater intensity of magnetic field.

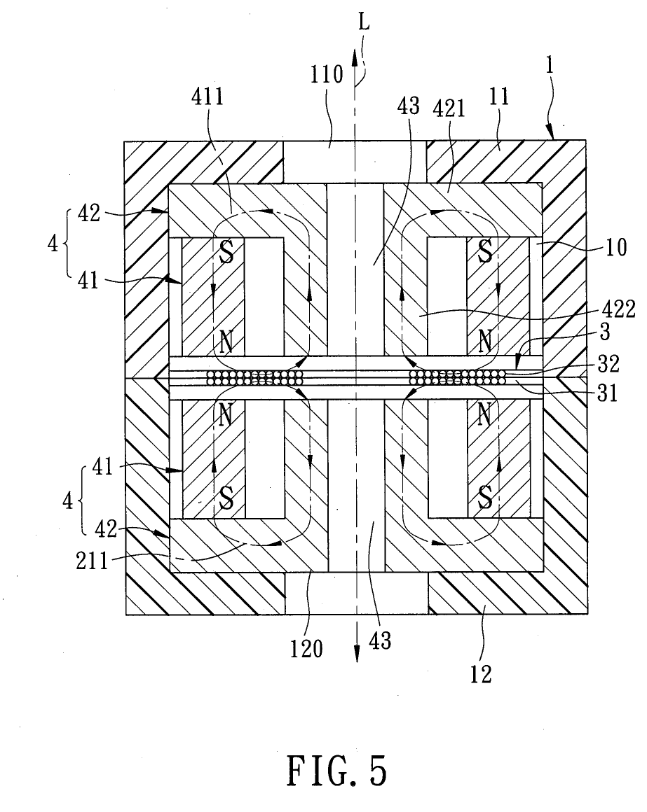

FIG. 5 illustrates the fourth preferred embodiment of a microphone according to this invention, which is a modification of the first preferred embodiment. In this embodiment, for each of the first and second magnet units 4, the yoke 42 has a large-diameter portion 421 disposed adjacent to and abutting against a corresponding one of the first and second walls 11, 12 of the head housing 1, and a small-diameter portion 422 having a diameter smaller than that of the large-diameter portion 421, connected to the large-diameter portion 421 and disposed adjacent to the response unit 3. The through hole 43 in the yoke 42 of each of the first and second magnet units 4 extends through the small-diameter portion 421 and the large-diameter portion 422 in the axial direction (L). The magnet 41 of each of the first and second magnet units 4 is in the form of a ring sleeved spacedly around the small-diameter portion 422 of the yoke 42 of a corresponding one of the first and second magnet units 4.

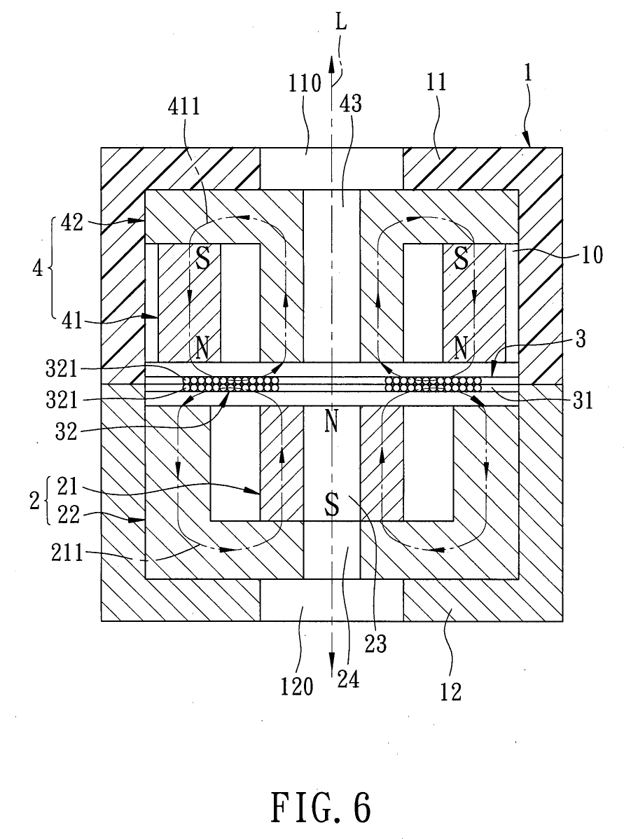

FIG. 6 illustrates the fifth preferred embodiment of a microphone according to this invention, which is a modification of the first preferred embodiment. Unlike the first preferred embodiment, the first magnet unit 4 has the same configuration as that of the fourth preferred embodiment of FIG. 5.

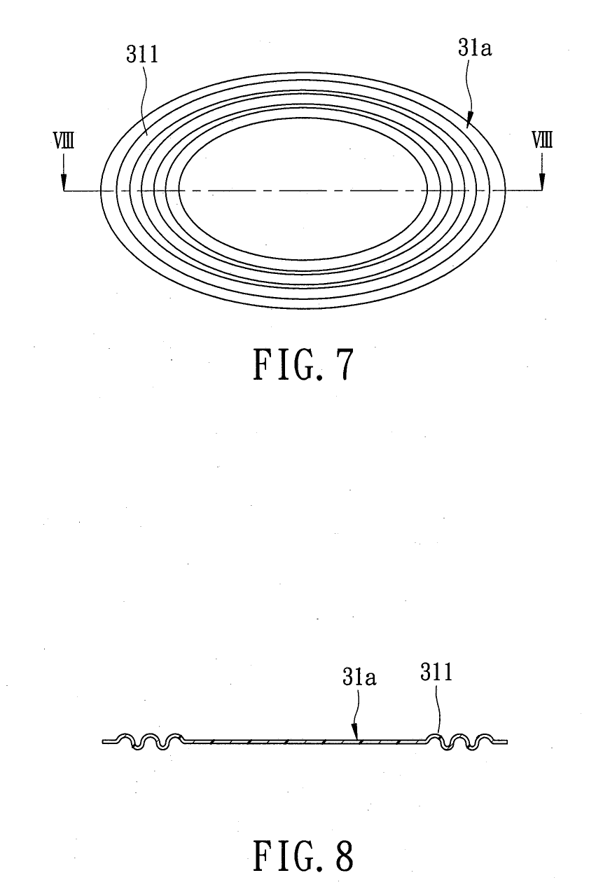

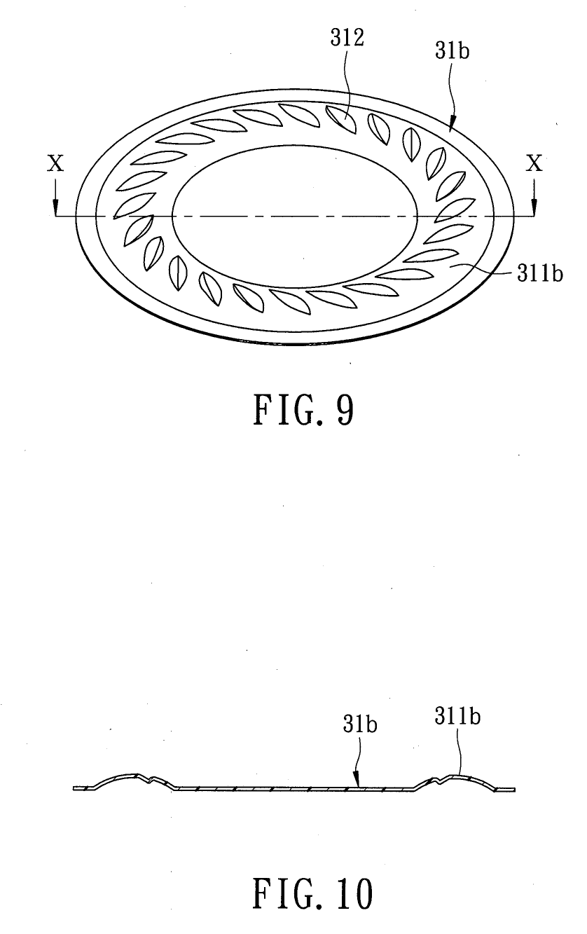

Furthermore, referring to FIGS. 7 to 10, there are provided two modified diaphragms (31a, 31b). One modified diaphragm (31a) shown in FIG. 7 has an annular peripheral portion 311 that is meandering in cross section along a radial direction of the diaphragm (31a), as shown in FIG. 8. The other modified diaphragm (31b) shown in FIG. 9 has an annular peripheral portion (311b) that is curved in cross section along a radial direction of the diaphragm (31b), as shown in FIG. 10, and that is formed with a plurality of leaf-shaped recesses 312 arranged spacedly in a circumferential direction. Due to the presence of the annular peripheral portion 311, (311b), stress of the diaphragm (31a, 31b) generated as a result of surface tension action can be overcome.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A microphone comprising:
a head housing;
first and second magnet units disposed in said head housing and spaced apart from each other in an axial direction of said head housing, said first and second magnet units generating respectively first and second magnetic fields; and
a response unit mounted in said head housing, disposed between said first and second magnet units in the axial direction, and including a diaphragm, and a conductive wiring disposed at said diaphragm;
whereby, when said diaphragm vibrates between said first and second magnet units in response to an external sound wave signal, an electrical signal corresponding to the sound wave signal is induced in said conductive wiring as a result of action of the first and second magnetic fields.

2. The microphone as claimed in claim 1, wherein said first and second magnet units have the same magnetic poles disposed adjacent to said diaphragm of said response unit.

3. The microphone as claimed in claim 1, wherein said head housing has first and second walls opposite to each other in the axial direction, each of said first and second walls being formed with a through hole.

4. The microphone as claimed in claim 3, wherein each of said first and second magnet units includes:
a magnet generating a plurality of magnetic lines of force that constitute a corresponding one of the first and second magnetic fields; and
a yoke for permitting the magnetic lines of force to pass therethrough, said yoke being formed with a through hole unit in fluid communication with said through hole in a corresponding one of said first and second walls of said head housing.

5. The microphone as claimed in claim 4, wherein said yoke of each of said first and second magnet units is in the form of a cap that has a flat wall portion disposed adjacent to the corresponding one of said first and second walls of said head housing and formed with said through hole unit, and an annular surrounding wall portion extending in the axial direction from a periphery of said flat wall portion toward said response unit and surrounding spacedly said magnet of a corresponding one of said first and second magnet units.

6. The microphone as claimed in claim 5, wherein said magnet of each of said first and second magnet units is in the form of a ring that has a central hole extending in the axial direction and in fluid communication with said through hole unit in said flat wall portion of said yoke of a corresponding one of said first and second magnet units.

7. The microphone as claimed in claim 5, wherein said through hole unit in said flat wall portion of said yoke of each of said first and second magnet units includes a plurality of through holes, each of which is in fluid communication with an annular space between said magnet and said annular surrounding wall portion of said yoke of the corresponding one of said first and second magnet units.

8. The microphone as claimed in claim 4, wherein:
said yoke of each of said first and second magnet units has a large-diameter portion disposed adjacent to a corresponding one of said first and second walls of said head housing, a small-diameter portion having a diameter smaller than that of said large-diameter portion, connected to said large-diameter portion and disposed adjacent to said response unit, and said through hole unit that extends through said small-diameter portion and said large-diameter portion in the axial direction; and
said magnet of each of said first and second magnet units is in the form of a ring sleeved spacedly around said small-diameter portion of said yoke of a corresponding one of said first and second magnet units.

9. The microphone as claimed in claim 4, wherein:
said yoke of said first magnet unit has a large-diameter portion disposed adjacent to said first wall of said head housing, a small-diameter portion having a diameter smaller than said large-diameter portion, connected to said large-diameter portion and disposed adjacent to said response unit, and said through hole unit that extends through said large-diameter portion and said small-diameter portion in the axial direction, said magnet of said first magnet unit being in the form of a ring sleeved spacedly around said small-diameter portion of said yoke of said first magnet unit; and
said yoke of said second magnet unit is in the form of a cap that has a flat wall portion disposed adjacent to said second wall of said head housing and formed with said through hole unit, and an annular surrounding wall portion extending in the axial direction from a periphery of said flat wall portion toward said response unit and surrounding spacedly said magnet of said second magnet unit, said magnet of said second magnet unit being in the form of a ring that has a central hole extending in the axial direction and in fluid communication with said through hole in said flat wall portion of said yoke of said second magnet unit.

10. The microphone as claimed in claim 1, wherein said conductive wiring of said response unit includes a spiral wiring embedded in said diaphragm.

11. The microphone as claimed in claim 10, wherein said spiral wiring includes two spiral wiring sections disposed respectively in two parallel planes.

12. The microphone as claimed in claim 1, wherein said diaphragm of said response unit is circular.

13. The microphone as claimed in claim 12, wherein said diaphragm has an annular peripheral portion that is meandering in cross section along a radial direction of said diaphragm.

14. The microphone as claimed in claim 12, wherein said diaphragm has an annular peripheral portion that is curved in cross section along a radial direction of said diaphragm.
